(19) United States
(12) Patent Application Publication
(10) Pub. No.: US 2011/0277010 A1
(43) Pub. Date: Nov. 10, 2011

(54) Audio video matrix switch with automatic line length signal compensator

(76) Inventor: Bill Paul, El Cajon, CA (US)

(21) Appl. No.: 12/231,903

(22) Filed: Sep. 5, 2008

Related U.S. Application Data
(60) Provisional application No. 60/967,741, filed on Sep. 5, 2007.

(51) Int. Cl. H04N 21/60

(52) U.S. Cl. 725/149

(57) ABSTRACT

An audio video matrix switch with automatic line length signal compensator provides for the determination of the line length and an automatic compensation signal to be generated, and for that compensation signal to be used to provide an equalizing gain to the transmitted signal thereby providing a higher quality signal to the output device. A system of the present invention includes a matrix switch assembly receiving inputs from a plurality of audio and video signal sources, and a plurality of audio and video output device. Each of the video output devices is equipped with a differential signal receiver and equalizer module which receives a routed signal from the matrix switch, determines the cable length, and provides a compensation signal to the audio and video signals to compensate for the cable length, and provides that compensated signal to an output device.

### RELATED APPLICATION

This application claims the benefit of priority to U.S. Provisional Patent Application Ser. No. 60/967,741 by the same inventor, filed Sep. 5, 2007, and currently co-pending.

### FIELD OF THE INVENTION

The present invention relates generally to audio and video distribution equipment. The present invention is more particularly, though not exclusively, applicable to an audio video distribution system which receives multiple signal inputs from multiple sources, and routes these signals to multiple audio video devices.

### BACKGROUND OF THE INVENTION

Audio and video equipment continues to improve in quality, durability, and versatility. These improvements include an increasingly higher quality video signal, clearer audio signals, and an overall decrease in the cost of high performance equipment. Due to this trend, it has become increasingly common to have an assortment of audio and video signal sources, matched with an assortment of audio and video signal output devices. For instance, in an ordinary home, it is entirely possible that several digital video disks (DVD) devices, several video cassette recorders (VCR) devices, and multiple compact disc (CD) players could be interconnected with a variety of televisions, video monitors, audio amplifiers, and the like.

In order to establish the interconnection of the various audio and video signal sources to desired audio and video output devices, it is necessary to establish electrical connections between the various components. In one application, it may be appropriate to hard wire the connections. However, this approach provides for very limited versatility in that a single source is wired to a single output device.

In an effort to avoid the one-source, one-output dilemma, the audio video matrix switch was developed to allow for the dynamic interconnection between various audio and video components. These matrix switches would provide for the user to determine the various connections, and could even provide to a quick re-configuration with the flip of a switch or a few remote control keystrokes. An exemplary audio and video distribution system is shown in FIG. 1, and includes a plurality of video and audio sources feeding signals to a distribution matrix switch configured to provide a plurality of output devices with the desired input signals.

These matrix switches, however, do not provide for the challenges which arise when the distances between the matrix switch and the various output devices varies. For instance, a standard matrix switch will send the identical video or audio signal regardless of whether the output device is ten feet away or a thousand feet away. For instance, referring to FIG. 2, a system in which the output devices range from 20′ to 1000′ feet is shown and not uncommon in the industry.

An additional challenge with the standard matrix switch device arises with the growing popularity of using inexpensive cabling, such as the twisted pair cable referred to as CAT-5 cable. While this cable is shielded, and may be readily available and rather inexpensive, it often introduces significant line loss when used on long length applications. In fact, a 1000 foot length of cable used on an installation may introduce a thirty percent loss in signal strength, with the higher frequency signals being most significantly reduced. This is particularly problematic in applications where high frequency signal quality is crucial to system performance.

In an effort to accommodate this unacceptable line loss, attempts have been made to introduce amplification into the system in order to compensate for the line loss. However, such amplification is expensive to implement, and requires a careful calibration of the system based on wire length and signal strength. Moreover, because installations of these high end video and audio distribution systems are often made using unskilled or inattentive workers, such solutions are seldom effective.

In light of the above, it would be advantageous to provide a system which provides an automatic line length compensation to be applied to the signals passing from a matrix switch to an audio and video output device.

### SUMMARY OF THE INVENTION

The present invention provides for the determination of the line length and an automatic compensation signal to be generated, and for that compensation signal to be used to provide an equalizing gain to the transmitted signal thereby providing a higher quality signal to the output device.

A system of the present invention includes a matrix switch assembly receiving inputs from a plurality of audio and video signal sources, and a plurality of audio and video output device. Each of the video output devices is equipped with a differential signal receiver and equalizer module which receives a routed signal from the matrix switch, determines the cable length, and provides a compensation signal to the audio and video signals to compensate for the cable length, and provides that compensated signal to an output device.

### BRIEF DESCRIPTION OF THE FIGURES

FIG. 1 depicts a distribution matrix switch, sources and devices;

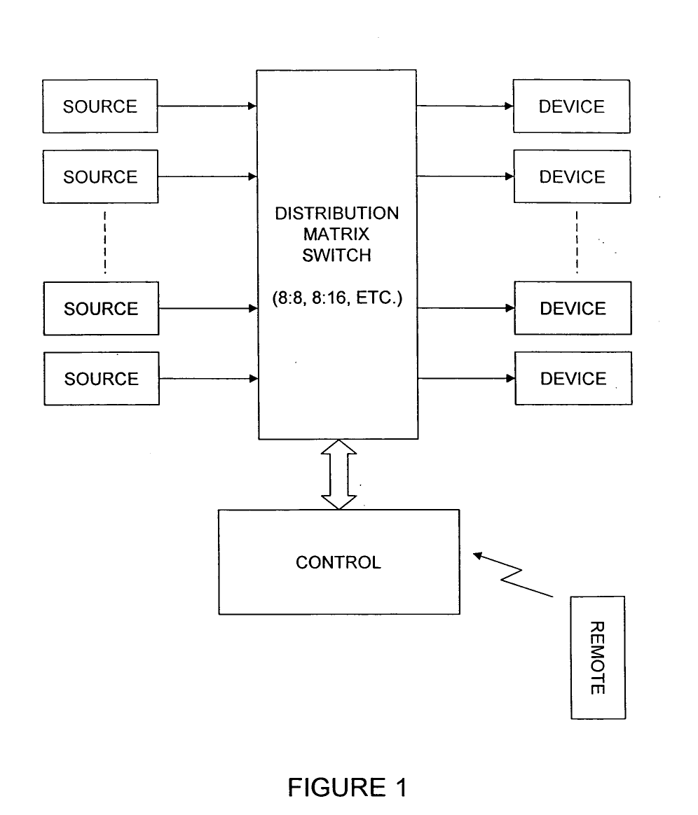

FIG. 2 depicts a distribution matrix switch and devices;

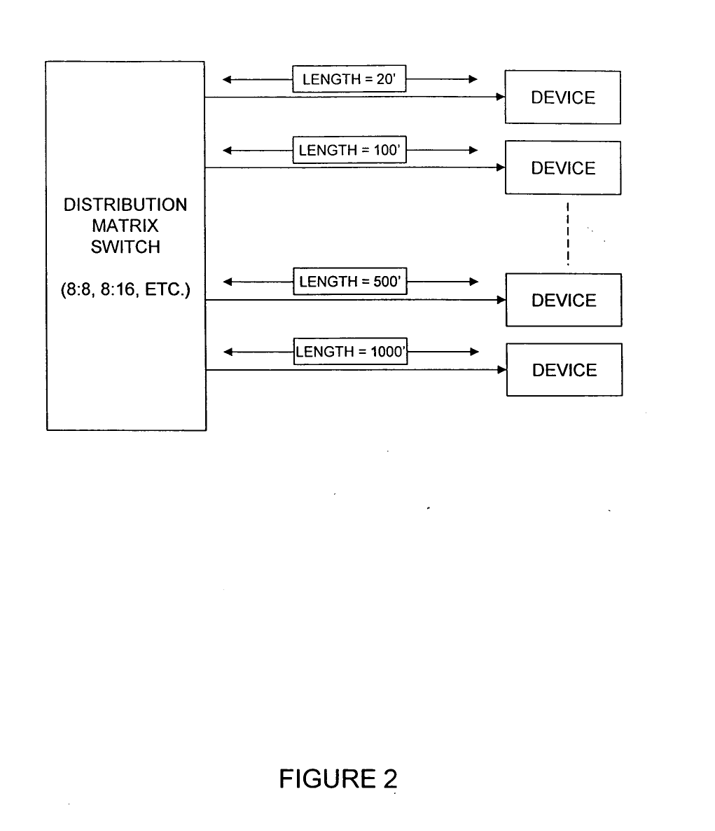

FIG. 3 is an exemplary audio and video distribution system of the present invention and includes a plurality of sources feeding audio and video signals to a distribution matrix switch configured to provide a plurality of output devices 108 with the desired input signals;

FIG. 4 is a differential signal receiver and equalizer module of the present invention and includes a differential receiver and equalizer circuit for cable compensation up to 1000 feet. Multiple Cat5 cable inputs will allow connection of YPbPr component video, digital audio (optionally composite video) and L+R analog audio, and a power signal, such as a DC power source, will also be present in the Cat5 cable;

FIG. 5 is an analog amplifier compensation circuit of FIG. 4 and includes a first stage to prescale the V-unregulated voltage from the PWR input from Cable A into the operating range of the opamp, R1 and R2 form a voltage divider to achieve this, C1 provides high frequency bypass for noise filtration, U1-A is a unity gain buffer stage and U1-B is configured as an inverting opamp with negative gain and DC offset and R3 and R4 set the overall gain. R5 and R6 form a voltage divider from a regulated voltage supply; and

FIG. 6 shows a differential signal receiver and equalizer module and includes an analog to digital converter which senses the voltage on the incoming power cable, and generates a corresponding digital signal that is provided to a microcontroller which compares the measured digital signal to a table containing known values, such as in memory.

### DESCRIPTION OF THE INVENTION

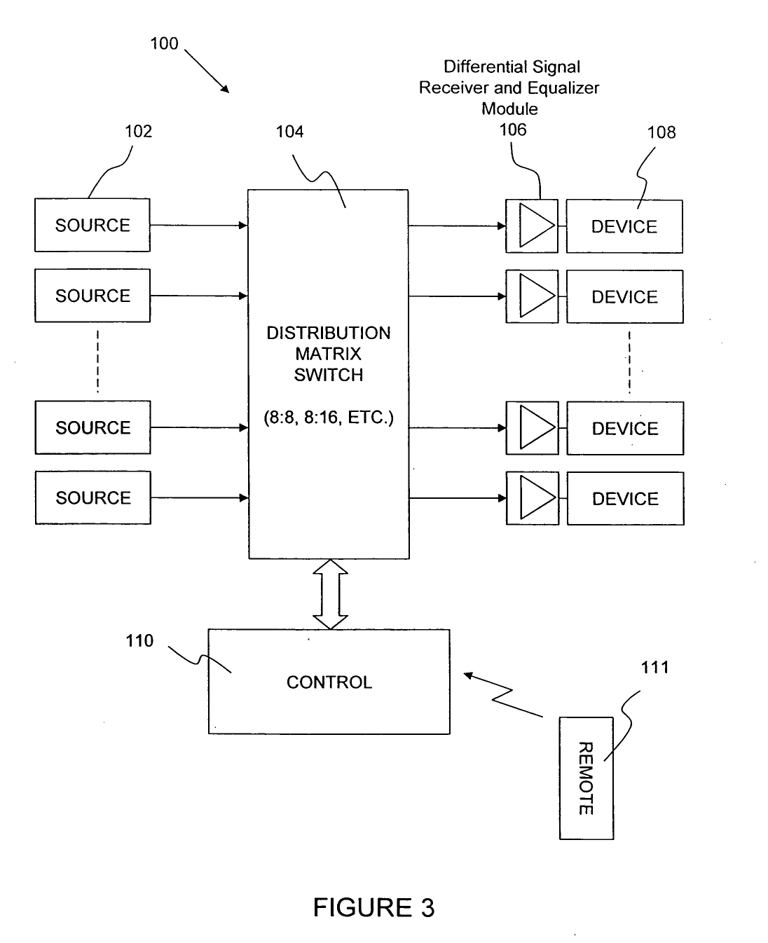

Referring now to FIG. 3, an exemplary audio and video distribution system of the present invention is shown and generally designated 100. System 100 includes a plurality of sources 102 feeding audio and video signals to a distribution matrix switch 104 configured to provide a plurality of output devices 108 with the desired input signals. These desired signals are passed through a differential signal receiver and equalizer module 106 which receives the routed signal from the matrix switch 104, determines the cable length, and provides a compensation signal used to compensate the audio and video signals for signal degradation resulting from the cable length. The differential audio and video signal module 106 then provides an audio and video signal to the output device 108.

In a preferred embodiment, the differential signal receiver and equalizer module of the present invention is designed to fit into a single gang wall outlet box for ease of installation, and includes output jacks suitable for using standard audio and video cables for connection to the output devices 108.

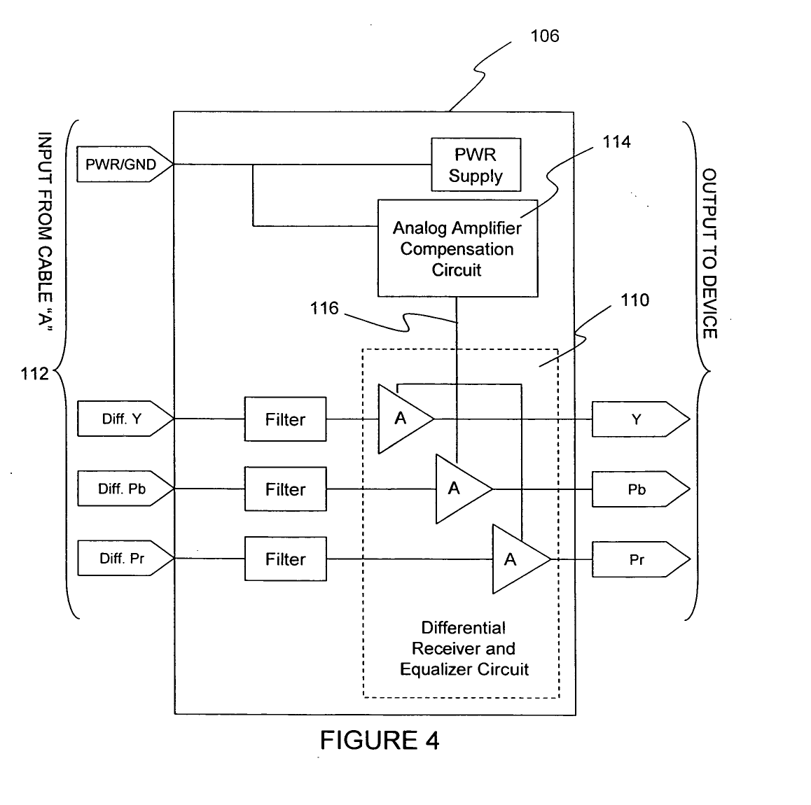

Referring to FIG. 4, the differential signal receiver and equalizer module 106 of the present invention includes a differential receiver and equalizer circuit 110 for cable compensation up to 1000 feet. Multiple Cat5 cable inputs 112 will allow connection of YPbPr component video, digital audio (optionally composite video) and L+R analog audio, and a power signal, such as a DC power source, will also be present in the Cat5 cable.

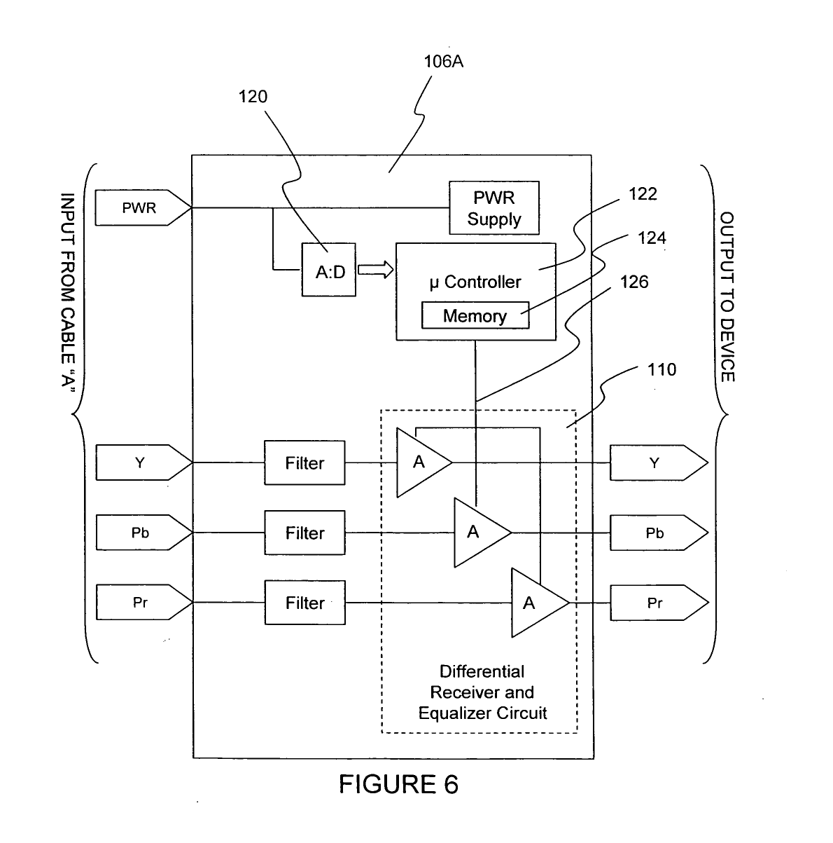

The Present invention includes a dual Cat5 differential signal receiver and equalizer circuit 110 which in a preferred embodiment, may be based on two triple differential receiver and equalizer integrated circuits. A separate Cat5 cable feeds each receiver with three pairs of signals each. For instance, a Cable A may contain Y, Pb, and Pr signals of component video, and cable B may contain Digital audio (or optionally composite video), left analog audio, and right analog audio. For ease of illustration, only Cable A is shown in FIGS. 4 and 6. Exemplary wiring may include:

CABLE A

| | |
|---|---|
| Pair 1 | Y |
| Pair 2 | Pb |
| Pair 3 | Pr |
| Pair 4 | PWR/GND |

CABLE B

| | |
|---|---|
| Pair 1 | Composite Video (Digital Audio) |
| Pair 2 | Left Audio |
| Pair 3 | Right Audio |
| Pair 4 | PWR/GND |

The digital audio, and all video signals output a signal with a gain of 2, and are back terminated with 75 ohms. The audio signals are set for a gain of 1, and have no output termination.

In a preferred embodiment of the present invention, cable A will handle high bandwidth video, so the signals must be equalized to compensate for up to 1000 feet of Cat5 cable. The differential receiver and equalizer circuit provides this compensation by a being provided with a control signal on its variable voltage input pin with a range of 0-1VDC.

Both Cable A and Cable B will provide power on the center pair of the RJ45 connector. 18VDC will be output from the Fulcrum driver board, but due to cable losses, this is calculated to drop to as low as 12VDC.

In a preferred embodiment, the differential receiver and equalizer circuit 110 will have a predictable current consumption of 108 mA typical. Based on laboratory testing of the device, operational current was consistently measured at 87 mA from +5V, and 102 mA to −5V. We concluded that the differences in currents are fed back through the various connections to ground.

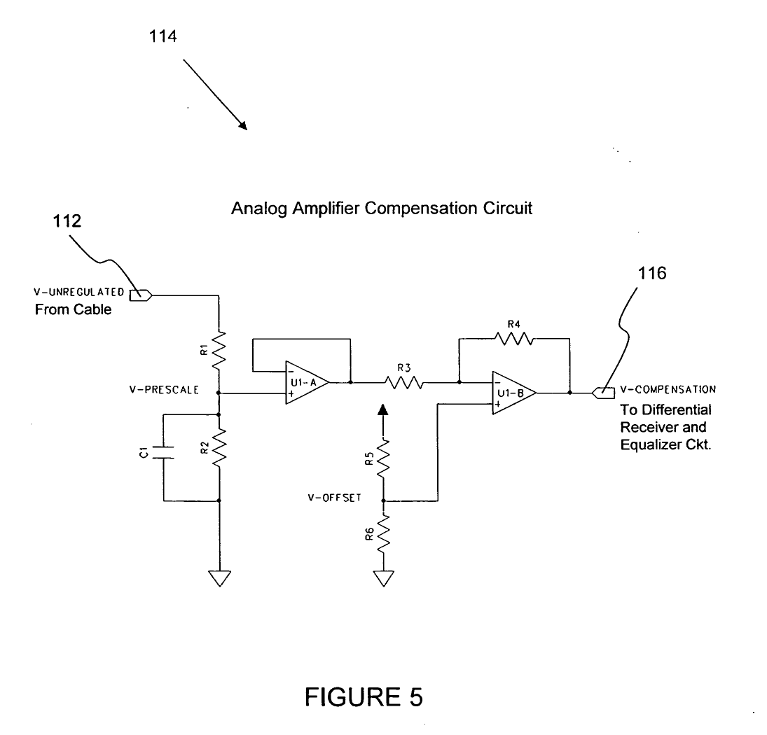

One embodiment of the present invention includes a dual channel low frequency operational amplifier (OpAmp) that is used in a compensation circuit (described below in conjunction with FIG. 5). The TL082 family is a suitable part for the needs, and is low cost. Typical quiescent current for the TL08x family is 1.4 mA per channel, so we will use 3 mA for the total package including loads. Both + and −5VDC are required to operate the above parts. National Semiconductor LM2662 (86% efficient) will be used for inverting +5 to −5, and LM2671 (90% efficient) will be used as a buck converter from Vᵢₙₚᵤₜ down to +5.

With two differential receiver and equalizer circuits enabled, the current approximately doubles. With two cables sharing that load, the current in one cable vs. two cables sharing should be similar, however small errors due to current imbalance may be present.

### Automatic Cable Compensation Circuit

The differential receiver and equalizer circuit 110 draws a fairly constant current, and when combined with a regulated voltage of +/−5V, power will also be constant. We will depend on this constant power draw to calculate the length of the cable. For instance, considering that Cat5 cable is specified as have 24 AWG solid copper wire, we can determine the resistance for a given length as being constant (our current travels out and back, so×2). With these two constants, we can calculate the distance based on the voltage drop, and therefore the compensation required.

$${R}_{24 AWG} = \frac{0.0257 ohms}{foot}$$

Based on our initial estimates of power consumption of differential signal receiver and equalizer module of the present invention, we can calculate:

Vₕₒᵣₙₑₜ=V_{fulcrum}−(Iₕₒᵣₙₑₜ·R_{24 AWG}·2)

Vₕₒᵣₙₑₜ=17.3−(0.096·(0.0257·1000)·2)

So while V_{fulcrum} is 17.3V, we can calculate V_{present invention} to be 12.37V for 1000 feet of Cat5 cable. As R_{24AWG} approaches 0, the voltage drop subtracted also approaches 0. Therefore, the voltage range expected at the differential signal receiver and equalizer module of the present invention is 12.37 to 17.3V.

From analysis of the differential receiver and equalizer circuit 110, the compensation voltage input range is from 0-1V, with 0V being no compensation, and 1V being max compensation, for 1000 feet of Cat5 cabling.

In the present technical application utilizing the differential receiver and equalization circuit, we require the following conditions:

V_{comp}=0V when V_{present invention}=17.3V and,

V_{comp}=1 V when V_{present invention}=12.4V

Using the slope equations m=(y2−y1/x2−x1) and y=mx+b, we can find:

$$m = ( \frac{0 - 1}{17.3 - 12.4} ) = - 0.204$$

$$b = 1 - ( - 0.204 \cdot 12.4 )$$

$${V}_{comp} = - 0.204 {V}_{hornet} + 3.53$$

As is shown in FIG. 5, this equation can be achieved using a single opamp solution where gain=m, and DC offset=b. In order to get the input signal within the operating range of the opamp (+/−5), a voltage divider will first reduce the input voltage by a factor of 5, and the opamp can operate at a gain of −1. An additional opamp stage is recommended on the input to further isolate the effects of the DC offset on the second stage.

Referring to FIG. 5, the analog amplifier compensation circuit 114 of FIG. 4 includes a first stage to prescale the V-unregulated voltage from the PWR input from Cable A into the operating range of the opamp. R1 and R2 form a voltage divider to achieve this. C1 provides high frequency bypass for noise filtration. U1-A is a unity gain buffer stage, and performs no part of the equation. It becomes necessary to isolate the prescale voltage from the next stage. U1-B is configured as an inverting opamp with negative gain and DC offset. R3 and R4 set the overall gain. R5 and R6 form a voltage divider from a regulated voltage supply. This offset voltage form the DC offset part of the equation. The overall gain of the system is calculated form both the initial prescale divider, and the opamp gain at U1-B. The bandwidth target is for the Present invention to recover 150 MHz (−3 db), with a flat response up to 70 MHz (+/−0.5 dB). Any added noise should not be perceivable to the viewer.

The DC compensation signal 116 from circuit 114 is fed into the differential receiver and equalizer circuit 110. More specifically, this DC compensation signal corresponds to the amount of equalization necessary to return the inputs 112 from the cable A to their original signal qualities when leaving matrix switch 104. For instance, the longer the length of the cable between the matrix 104 and device 108, the greater the voltage drop within the cable. This voltage drop is used by the analog amplifier compensation circuit 114 to generate the compensation signal 116. This substantially DC compensation signal 116 is provided to the differential receiver and equalizer circuit to provide the necessary equalization to the video and audio signals.

In an alternative embodiment, the differential signal receiver and equalizer module 106 of the present invention may include a digital circuit to determine the length of the cable. For example, referring to FIG. 6, differential signal receiver and equalizer module 106A is shown and includes an analog to digital converter 120 which senses the voltage on the incoming power cable, and generates a corresponding digital signal.

The digital signal from analog to digital converter 120 is provided to a microcontroller 122 which compares the measured digital signal to a table containing known values, such as in memory 124. For instance, values in memory 124 may include a collection of digital signals corresponding to various lengths of cable (e.g. voltage readings indicating a particular voltage drop corresponding to cable losses). Using this table, the microcontroller 122 may determine approximate cable length and generate an output signal 126 corresponding to the compensation signal necessary to restore the audio and video signals. Differential receiver and equalizer circuit 110 utilizes the output signal 126 to restore the inputs 112 from cable A to suitable levels.

Utilizing the system 100 of the present invention, an audio and video matrix switch may be implemented and installed without any sophisticated installation practices. Specifically, as the cables are installed from the matrix switch 104 to devices 108, there is no cable length calibration or adjustment needed to insure optimum performance. By incorporating differential signal receiver and equalizer modules 106 for each device 108, the audio and video signal characteristics necessary for the proper device operation are automatically provided.

1. An audio video matrix switch comprising:
a matrix switch assembly receiving audio and video signals from a plurality of audio and video signal sources;
a plurality of audio and video output devices, each said device in electrical connection with said matrix switch assembly;
a plurality of differential signal receiver and equalizer modules, one said module in electrical connection between said matrix switch assembly and said devices; wherein each said module receives a routed signal from the matrix switch, determines the cable length, and provides a compensation signal to the audio and video signals to compensate for the cable length, and provides that compensated signal to said output device.
